(19) United States
(12) Patent Application Publication
(10) Pub. No.: US 2008/0289532 A1
(43) Pub. Date: Nov. 27, 2008

(54) AQUEOUS RELEASE AGENTS AND THEIR USE IN THE PRODUCTION OF POLYURETHANE MOLDING

(75) Inventors: Torsten Henning, Schwerin (DE); Anja Kindling, Kreuzau (DE); Ralf Althoff, Haltern am See (DE)

Correspondence Address: SCULLY SCOTT MURPHY & PRESSER, PC, 400 GARDEN CITY PLAZA, SUITE 300, GARDEN CITY, NY, 11530, US

(73) Assignee: EVONIK GOLDSCHMIDT GMBH, Essen (DE)

(21) Appl. No.: 12/103,908

(22) Filed: Apr. 16, 2008

(30) Foreign Application Priority Data
May 25, 2007 (DE) 102007024493.4

(51) Int. Cl. B29C 33/60; C09D 5/20

(52) U.S. Cl. 106/2; 264/300

(57) ABSTRACT

The invention provides aqueous release agent dispersions for producing polyurethane moldings, substantially including
A) at least one agent having release activity, and selected from the group consisting of soaps, oils, waxes and silicones, and
B) emulsifiers and
C) if desired, foam stabilizers, and
D) if desired, viscosity modifiers, and
E) if desired, auxiliaries and additives, and
F) at least one alkali metal or alkaline earth metal carboxylate, and
G) water.

### FIELD OF THE INVENTION

The invention relates to aqueous release agents and to their use in the production of polyurethane moldings.

### BACKGROUND OF THE INVENTION

It is known that polyurethane systems used for producing moldings exhibit strong adhesion to the mold materials that are used, preferably highly thermally conductive materials such as metals. For the demolding of the polyurethane moldings, there is a need for release agents, which are applied to the mold walls that come into contact with polyurethanes and/or with the polyurethane reaction mixture.

Release agents of this kind are composed of dispersions or emulsions of waxes, soaps, oils and/or silicones in solvents such as hydrocarbons or water.

After application of the release agent to the mold, the solvent evaporates and the non-volatile substances with release activity form a thin release film which is intended to ensure that the polyurethane molding can be removed easily from the mold after it has been produced.

In order to reduce the burden of organic materials on the environment, there is a high level of interest in aqueous based release agents that are free from volatile organic material. However, the aqueous release agents that are on the market have the disadvantage, as compared with conventional release agents, i.e., those containing organic solvents, that, following the evaporation of a major part of water, there is always a thin water film that remains in the mold, which does not undergo volatilization at the typical mold temperatures of 45° C. to 80° C., preferably 50° C. to 75° C. Also, the remaining thin water film enters into reactions with the isocyanate compounds of the polyurethane system, and oftentimes leads to very hard and rigid polyurea compounds. As a result, the mold surfaces are adversely affected. They acquire a so-called build-up, which must be removed by laborious cleaning.

In addition to the release effect that is actually needed, the release agent also takes on further functions. For instance, the release agent also greatly influences the surface of the polyurethane molding, which is to be fine-pored or smooth and uniform, for the purpose, among others, of ensuring that the fiished moldings can be readily, i.e., easily, covered with fabrics or leather.

In the course of ever greater optimization of production rates, in particular in the automobile supplier industry, it is precisely the above-described property of the coverability of the polyurethane molding that has become an important quality feature.

One option of improving the surface quality of the polyurethane foam moldings is to use substances which catalyze and thereby accelerate the polyol-isocyanate reaction. The commercial aqueous release agents for polyurethane moldings therefore typically include what are called tin accelerants, in other words catalysts based on organotin compounds. As well as improving the surface quality, these tin accelerants also have a release assist effect, since they accelerate the polyol-isocyanate reaction at the interface between foam and release film.

Tin accelerants also alleviate the above-described problem of mold build-up, since as a result of the release assist effect of the tin accelerator it is not necessary to apply so much release agent to the mold in order to achieve effective release.

Particularly suitable are di-n-butyltin dicarboxylates, as described in EP 1 082 202. Principally dibutyltin dilaurate (DBTL) is used, as described, for example, in DE 35 41 513 or EP 0 164 501.

As is known, DBTL is labeled R 50/53 (dangerous for the environment, very toxic to aquatic organisms) and harbors risks to the environment during storage and transport of release agents which contain DBTL.

Consequently, many polyurethane foam molding customers, in the footwear sole or mattress sector, for example, are already demanding that the release agent used be free from tin compounds.

Moreover, the ECB (European Chemical Bureau) is undertaking a categorization which labels organotin compounds as reproductive toxins, with the R phrases R60-R61. This will affect certain di-n-butyltin dicarboxylates, among them DBTL. In that case it will be virtually impossible to use release agents including organotin compounds any longer.

### SUMMARY OF THE INVENTION

The present invention provides aqueous mold release agents which are free from organotin compounds, yet exhibit an effective release action. Moreover, the present invention provides aqueous mold release agents that do not cause any build-up on the mold walls and favorably influence the surfaces of the polyurethane moldings, in other words leaving them fine-pored, smooth and uniform.

Surprisingly it has been found by the applicants of the present invention that the use of alkali metal or alkaline earth metal salts of organic acids as catalysts in amounts of 0.01% to 10% by weight, preferably 0.05% to 5% by weight, in particular 0.1% to 3% by weight, in aqueous dispersions comprising conventional, release-active substances such as waxes, soaps, oils and/or silicones in amounts of 0.5% to 40% by weight, preferably 3% to 20% by weight, provides the benefits mentioned in the previous paragraph.

The invention accordingly provides aqueous release agent dispersions for producing polyurethane moldings, substantially comprising (sum of the fractions of components A, B, C, D, E, F and G corresponds to at least 50% by weight, preferably at least 80% by weight, and more preferably 100% by weight of the dispersion):
A) at least one agent having release activity, and selected from the group consisting of soaps, oils, waxes, and silicones;
B) emulsifiers;
C) if desired, foam stabilizers;
D) if desired, viscosity modifiers;
E) if desired, auxiliaries and additives;
F) 0.01% to 10% by weight, preferably 0.05% to 5% by weight, of at least one alkali metal or alkaline earth metal carboxylate; and
G) water.

The aqueous release agent dispersions of the invention are preferably used as external release agents and therefore contain no components for preparing polyurethanes.

The invention also provides a method of using the inventive aqueous release agent dispersion in the production of polyurethane moldings. The inventive method includes:
heating a mold to a mold temperature of 45° C. to 80° C.;
applying an aqueous release agent to said mold, said aqueous release agent including:
   A) at least one agent having release activity, and selected from the group consisting of soaps, oils, waxes, and silicones;
   B) emulsifiers;
   C) 0.01% to 10% by weight, preferably 0.05% to 5% by weight, of at least one alkali metal or alkaline earth metal carboxylate; and
   D) water;
adding a reactive polyurethane system comprising at least a polyol and a polyisocyanate to said mold;
closing said mold and curing said mold containing said reactive polyurethane system and said aqueous release agent to provide a molded article; and
opening said mold and removing said molded article from said mold.

### DETAILED DESCRIPTION OF THE INVENTION

The present invention, which provides an aqueous release agent and a method of using the same for the production of polyurethane moldings, will now be described in greater detail.

As stated above, the present invention provides an aqueous release agent that comprises at least one agent having release activity, and selected from the group consisting of soaps, oils, waxes, and silicones; emulsifiers; 0.01% to 10% by weight, preferably 0.05% to 5% by weight, of at least one alkali metal or alkaline earth metal carboxylate; and water. The inventive aqueous release agent may optionally include foam stabilizers, viscosity modifiers, and auxiliaries and additives. It is observed that the inventive aqueous release agent does not however include any organotin compounds.

In one embodiment of the invention, a preferred aqueous release agent dispersion is provided that comprises:
A) at least one agent having release activity, and selected from the group consisting of soaps, oils, waxes, and silicones;
B) emulsifiers;
C) at least one foam stabilizer; and/or
D) at least one viscosity modifier; and/or
E) at least one auxiliary and/or additive;
F) 0.01% to 10% by weight, preferably 0.05% to 5% by weight, of at least one alkali metal or alkaline earth metal carboxylate; and
G) water.

In another embodiment of the invention, the dispersions particularly consist of:
A) 0.5% to 40% by weight of at least one agent having release activity, and selected from the group consisting of soaps, oils, waxes, and silicones;
B) 0.1% to 10% by weight of emulsifiers;
C) 0% to 5% by weight, preferably 0.1% to 5% by weight, of foam stabilizers;
D) 0% to 5% by weight, preferably 0.1% to 5% by weight, of viscosity modifiers;
E) 0% to 2% by weight, preferably 0.1% to 2% by weight, of typical auxiliaries and/or additives, in particular preservatives, bactericides, fungicides, and/or preferably antioxidants;
F) 0.05% to 10% by weight, preferably 0.1% to 5% by weight, of at least one alkali metal or alkaline earth metal carboxylate; and
G) water.

As component F, dispersions of the invention preferably contain alkali metal or alkaline earth metal salts of organic acids of the formula R—COOH, where R is preferably an unbranched or branched C₂ to C₂₂ hydrocarbon radical, optionally containing multiple bonds, preferably an alkyl radical, alkenyl radical and/or aryl radical.

To prepare suitable salts, the monobasic carboxylic acids that are customary and known in this field may be used. The salts contained in the dispersion in accordance with the invention may also be based on natural vegetable or animal fats and oils in particular those having 2 to 22 carbon atoms, preferably having ≧2 to 18 C atoms, in particular having 2 to 12 carbon atoms. The dispersions of the invention more preferably contain salts of one or more acids selected from acetic acid, propionic acid, n-butyric acid, isobutyric acid, heptanoic acid, caproic acid, caprylic acid, 2-ethylhexanoic acid, capric acid, neodecanoic acid, lauric acid, myristic acid, palmitic acid, palmitoleic acid, isostearic acid, stearic acid, oleic acid, linoleic acid, petroselinic acid, elaidic acid, arachidic acid, behenic acid, erucic acid, gadoleic acid, rapeseed oil fatty acid, soybean oil fatty acid, sunflower oil fatty acid, tall oil fatty acid, and also salts of the technical mixtures obtained in the course of pressurized cleavage. In principle, all fatty acids with similar chain distribution are suitable.

The unsaturated components content in the fatty acid radical can be adjusted—if necessary—to a desired iodine number by means of the known catalytic hydrogenation processes or be achieved by blending fully hydrogenated with unhydrogenated fatty components.

The iodine number, as a numerical measure of the average degree of saturation of a fatty acid, is the amount of iodine absorbed by 100 g of the compound for the saturation of the double bonds.

The dispersions of the invention comprise, as the at least one alkali metal or alkaline earth metal carboxylate, preferably salts which as their alkali metal or alkaline earth metal cation contain preferably lithium, sodium and/or potassium cations, more preferably exclusively potassium cation. With particular preference the dispersion of the invention comprises, as the at least one alkali metal or alkaline earth metal carboxylate, potassium acetate or potassium octoate.

The alkali metal or alkaline earth metal carboxylates can be prepared from the organic acids R—COOH by processes known from the literature or are available as commercial products under the respective brand names, such as ultrapure potassium acetate (Merck KGaA), PC CAT® TKA (Nitroil Europe) and Polycat® 46 (Air Products) or potassium octoate as Tegokate K15 (TIB Chemicals GmbH), Fomrez® EC-686 (Witco Chemicals Corporation), Dabco® K-15 (Air Products) and PC CAT® TKO (Nitroil Europe) or mixtures of potassium acetate and potassium octoate such as PC Cat° K1 (Nitroil Europe).

These salts have the advantage that they are not classified as toxic and are not classified as dangerous for the environment. These salts also have the advantage that they catalyze the reaction of the polyols with the isocyanates at the interfaces of the reaction mixture/mold surface, and additionally influence the surface quality of the foam in the direction of the required cell sizes and structure: the latter should lie within a certain cell size (fine-celled, but no microfoam or coarse foam) and should be slightly open-pored (not closed or predominantly open). These criteria are largely practical, i.e., can be optimized by means of a few range finding tests, and make it easier to cover the molding with, for example, textile coverings.

The invention farther provides for the use of the inventive dispersions as external release agents in the production of polyurethane moldings.

As conventional substances with release activity (i.e., the least one agent having release activity, and selected from the group consisting of soaps, oils, waxes, and silicones; component A) it is possible in the dispersion of the invention to make use for example of:
waxes, i.e., liquid, solid, natural or synthetic waxes, also oxidized and/or partly hydrolyzed; esters of carboxylic acids with alcohols or fatty alcohols, oils, such as hydrocarbons which are viscous or liquid at room temperature, if desired—but not preferably—used with unsaturated oligomeric and/or polymeric hydrocarbons; silicones, such as polydimethylsiloxanes, substituted if desired by aliphatic or aromatic hydrocarbon radicals.

Typical waxes having release activity are set out for example in the company brochures “Waxes by Clariant, production, characteristics and applications”, Clan ant, May 2003, and “Formtrennmittel mit Vestowax®” from Degussa.

Typical emulsifiers that can be included are one or more compounds selected from the following groups:
I) anionic emulsifiers such as
   alkyl ether carboxylates, alkyl sulfates, fatty alcohol ethoxylated ether sulfates, alpha-olefinsulfonates, alkyl phosphates, alkyl polyether phosphates, alkylsulfosuccinates,
II) nonionic emulsifiers such as
   ethoxylated fatty alcohols, ethoxylated oxo-process alcohols, and other alcohol ethers, fatty amines such as dimethylalkylamines, fatty acid alkanol amides, fatty acid esters with alcohols, including glycerol esters or polyglycerol esters or sorbitol esters,
III) cationic emulsifiers such as
   acidified alkyldimethylamines, quaternary nitrogen compounds,
IV) zwitterionic surfactants.

The emulsifiers are preferably included in amounts of 0.1% to 10% by weight, preferably 0.5% to 6% by weight in the dispersion as component B.

As component C (i.e., the optional foam stabilizer) there may be one or more of the compounds known in the prior art as foam stabilizers present in the dispersion of the invention. These compounds may be selected, for example, from the group consisting of polyurethane foam stabilizers, such as polysiloxane-polyether copolymers, for example.

As component D (i.e., the optional visocosity modifier) it is possible for one or more of the compounds known in the prior art as viscosity modifiers to be present in the dispersion of the invention. Examples of customary viscosity modifiers are typical thickeners, such as polyacrylic acid derivatives referred to as carbomers, or other polyelectrolyte thickeners, such as water-soluble cellulose derivatives or else xanthan gum. As viscosity modifiers in aqueous formulations it is also possible to consider aliphatic hydrocarbons, in other words petroleum fractions, which swell the waxes employed and in that way exhibit a thickening effect.

As typical auxiliaries and additives (i.e., optional component E) it is possible to include one or more of the compounds that are known in the prior art in the dispersion of the invention as component E. Examples of preferred auxiliaries and/or additives are conventional preservatives such as bactericides or fungicides, e.g., Euxyl® 100, from Schülke & Mayr, Mergal® K 12, from Troy, or antioxidants e.g., Irganox® 1520 L, manufactured by Ciba.

The dispersions of the invention can be prepared, for example, by the processes known in the prior art. The dispersions of the invention are preferably prepared in such a way that the emulsifier is charged with substances with release activity, in a melted form (below the boiling temperature of water), to introduce part of the water under a high shearing force, and then to add the remaining water, containing the further components, under a low shearing force.

The release agent dispersion of the invention may be used in the customary way. Conventionally, when preparing polyurethane moldings, the mold is brought to the desired mold temperature of 45 to 80° C., preferably 50 to 75° C., and is sprayed with release agent, a certain time—depending on the proportion of water about 1 to 10 minutes—is allowed to pass until the majority of the water has evaporated, and then the reactive polyurethane system comprising polyols, polyisocyanates, and, if desired, further additives such as catalysts, foam stabilizers, and blowing agents, is pumped in. The mold is closed and, after the cure time, is opened and the molding is removed.

The following, non-limiting, examples are provided to illustrate the inventive aqueous release agents and to demonstrate some advantages that can be obtained when using the same in the production of polyurethane moldings.

List of substances used:
DC® 190=polyethersiloxane, manufacturer: Air Products,
Polyöl®130=polybutadiene with an average molar mass of about 3000 and an iodine number of about 450 g iodine/100 g, manufacturer: Evonik Degussa GmbH,
fatty amine=R—NH₂ with R═C₂₋₂₂, unbranched or branched alkyl radical,
microwax=commercial waxes having a solidification temperature of 50° C. to 90° C.,
polyethylene wax=commercial waxes having a solidification temperature of 50° C. to 90° C.,
Tegokat® K15=potassium octoate, manufacturer: TIB Chemicals GmbH
ultrapure potassium acetate, manufacturer: Merck KGaA
Kosmos® 19=dibutytin dilaurate (DBTL), manufacturer: Evonik Goldschmidt GmbH
Desmophen® PU 50REII=polyetherpolyol, manufacturer: Bayer,
Tegoamin® TA 33, manufacturer: Evonik Goldschmidt GmbH
Tegostab® B 4113=organically modified siloxane, manufacturer: Evonik Goldschmidt GmbH,
Suprasec® X 2412=diphenylmethane 4,4′-diisocyanate, manufacturer: Huntsman.

### EXAMPLE 1

Release Agent 1, Without Catalyst:

1.2% by weight of polyethylene wax (solification point 60° C.), 6.4% by weight of microwax (solidification point 70° C.), 6.0% by weight of Polyöl® 130, 1.4% by weight of fatty amine, 0.1% by weight of acetic acid (60% in water), 1.5% by weight of DC®190, 83.4% by weight of water.

### EXAMPLE 2

Release Agent 2, With DBTL:

1.2% by weight of polyethylene wax (solidification point 60° C.), 6.4% by weight of microwax (solidification point 70° C.), 6.0% by weight of Polyöl® 130, 1.4% by weight of fatty amine, 0.1% by weight of acetic acid (60% in water), 1.5% by weight of DC® 190, 0.4% by weight of Kosmos® 19, 83.0% by weight of water.

### EXAMPLE 3

Release Agent 3, With Potassium Octoate:

1.2% by weight of polyethylene wax (solification point 60° C.), 6.4% by weight of microwax (solidification point 70° C.), 6.0% by weight of Polyöl® 130, 1.4% by weight of fatty amine, 0.1% by weight of acetic acid (60% in water), 1.5% by weight of DC® 190, 0.3% by weight of Tegokat® K15, 83.1% by weight of water.

### EXAMPLE 4

Release Agent 4, With Potassium Acetate:

1.2% by weight of polyethylene wax (solidification point 60° C.), 6.4% by weight of microwax (solidification point 70° C.), 6.0% by weight of Polyöl® 130, 1.4% by weight of fatty amine, 0.1% by weight of acetic acid (60% in water), 1.5% by weight of DC® 190, 0.3% by weight of ultrapure potassium acetate, 83.1% by weight of water.

Release Agent Tests:

The release agents were applied by spraying using a 0.5 mm nozzle, in amounts of 20 g/m², similar to those used in practice, to metal test plates, and a foamable polyurethane system composed of 100 parts of Desmophen® PU 50REII, 3.5 parts of water, 0.5 part of Tegomin® TA 33, 1.5 parts of diethanolamine, 1 part of Tegostab® B4113, 78 parts of Suprasec® X 2412, was foamed onto these plates in a box mold at 55° C.

After curing had taken place (10 minutes), the metal plates were peeled from the foam using a spring force meter, in order to measure the extent of the release effect.

Evaluation of the Release Tests:

| Release | Force for peeling the metal | |
|---|---|---|
| agent | plate from the foam [kg] | Assessment of the foam surface |
| 1 | 1.1 | skin formation, smeary, difficult to |
| | | cover, since excessive frictional |
| | | forces arise on the closed and |
| | | therefore relatively large surface |
| 2 | 0.8 | slightly open-pored, dry, readily |
| | | coverable |
| 3 | 0.8 | slightly open-pored, dry, readily |
| | | coverable |
| 4 | 0.9 | slightly open-pored, dry, readily |
| | | coverable |

As is apparent from the table above, the non-toxic potassium salts used in accordance with the invention fulfill the requirements in practice with regard to coverability and pore properties. Moreover, the inventive aqueous release agents exhibit significant technical advantages over the control release agent without catalyst (release agent 1) and are equal in technical effect to the toxic tin compounds (release agent 2).

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

We claim:

1. An aqueous release agent dispersion for producing polyurethane moldings, comprising:
at least one agent having release activity, and selected from the group consisting of soaps, oils, waxes and silicones;
emulsifiers;
0.05% to 10% by weight of at least one alkali metal or alkaline earth metal carboxylate; and
water.

2. The dispersion of claim 1, further comprising at least one of a foam stabilizer, a viscosity modifier, an auxiliary and an additive.

3. The dispersion of claim 1, comprising:
A) 0.5% to 40% by weight of said at least one agent having release activity, and selected from the group consisting of soaps, oils, waxes, and silicones;
B) 0.1% to 10% by weight of said emulsifiers;
C) 0% to 5% by weight of a foam stabilizer;
D) 0% to 5% by weight of viscosity modifiers;
E) 0% to 2% by weight of at least one of a preservative, a bactericide, a fungicide, and an antioxidant;
F) 0.05% to 10% by weight of said at least one alkali metal or alkaline earth metal carboxylate; and
G) said water.

4. The dispersion of claim 1, wherein said least one alkali metal or alkaline earth metal carboxylate is at least one potassium salt of organic acids of the formula R—COOH, where R is an optionally branched C₂ to C₂₂ hydrocarbon radical optionally containing multiple bonds.

5. The dispersion of claim 1, wherein said least one alkali metal or alkaline earth metal carboxylate is potassium octoate or potassium acetate.

6. An aqueous release agent dispersion for producing polyurethane moldings consisting of:
A) 0.5% to 40% by weight of at least one agent having release activity, and selected from the group consisting of soaps, oils, waxes, and silicones;
B) 0.1% to 10% by weight of emulsifiers;
C) 0% to 5% by weight of foam stabilizers;
D) 0% to 5% by weight of viscosity modifiers;
E) 0% to 2% by weight of at least one auxiliary and an additive;
F) 0.05% to 10% by weight of at least one alkali metal or alkaline earth metal carboxylate; and
G) water.

7. The dispersion of claim 6, wherein said least one alkali metal or alkaline earth metal carboxylate is at least one potassium salt of organic acids of the formula R—COOH, where R is an optionally branched C₂ to C₂₂ hydrocarbon radical optionally containing multiple bonds.

8. The dispersion of claim 6, wherein said least one alkali metal or alkaline earth metal carboxylate is potassium octoate or potassium acetate.

9. A method of producing a polyurethane molding comprising:
heating a mold to a mold temperature of 45° C. to 80° C.;
applying an aqueous release agent to said mold, said aqueous release agent including:
at least one agent having release activity, and selected from the group consisting of soaps, oils, waxes, and silicones;
emulsifiers;
0.01% to 10% by weight of at least one alkali metal or alkaline earth metal carboxylate; and
water;
adding a reactive polyurethane system comprising at least a polyol and a polyisocyanate to said mold;
closing said mold and curing said mold containing said reactive polyurethane system and said aqueous release agent to provide a molded article; and
opening said mold and removing said molded article from said mold.

10. The method of claim 9, wherein said aqueous release agent further comprises at least one of a foam stabilizer, a viscosity modifier, an auxiliary and an additive.

11. The method of claim 9, wherein said aqueous release agent comprises:
A) 0.5% to 40% by weight of said at least one agent having release activity, and selected from the group consisting of soaps, oils, waxes, and silicones;
B) 0.1% to 10% by weight of said emulsifiers;
C) 0% to 5% by weight of a foam stabilizer;
D) 0% to 5% by weight of viscosity modifiers;
E) 0% to 2% by weight of at least one of a preservative, a bactericide, a fingicide, and an antioxidant;
F) 0.05% to 10% by weight of said at least one alkali metal or alkaline earth metal carboxylate; and
G) said water.

12. The method of claim 9, wherein said least one alkali metal or alkaline earth metal carboxylate is at least one potassium salt of organic acids of the formula R—COOH, where R is an optionally branched C₂ to C₂₂ hydrocarbon radical optionally containing multiple bonds.

13. The method of claim 9, wherein said least one alkali metal or alkaline earth metal carboxylate is potassium octoate or potassium acetate.

14. The method of claim 9, wherein said aqueous release agent consists of:
A) 0.5% to 40% by weight of said at least one agent having release activity, and selected from the group consisting of soaps, oils, waxes, and silicones;
B) 0.1% to 10% by weight of said emulsifiers;
C) 0% to 5% by weight of a foam stabilizer;
D) 0% to 5% by weight of a viscosity modifiers;
E) 0% to 2% by weight of at least one auxiliary and an additive;
F) 0.05% to 10% by weight of said at least one alkali metal or alkaline earth metal carboxylate; and
G) said water.
